(19) United States
(12) Patent Application Publication
(10) Pub. No.: US 2014/0269554 A1
(43) Pub. Date: Sep. 18, 2014

(54) SELF-CALIBRATION TECHNIQUES FOR IMPLICIT BEAMFORMING

(71) Applicant: Celeno Communications (Israel) Ltd., Raanana (IL)

(72) Inventors: Nir Shapira, Ra'anana (IL); Gilad Kirshenberg, Ra'anana (IL)

(73) Assignee: Celeno Communications (Israel) Ltd., Raanana (IL)

(21) Appl. No.: 14/203,589

(22) Filed: Mar. 11, 2014

Related U.S. Application Data
(60) Provisional application No. 61/786,998, filed on Mar. 15, 2013.

(51) Int. Cl. H04B 17/00

(52) U.S. Cl. CPC H04B 17/0007
USPC 370/329

(57) ABSTRACT

A method for communication includes, in a communication device that includes a plurality of transmission/reception (TX/RX) chains, each including a respective TX chain and a respective RX chain coupled to a respective antenna, transmitting a calibration signal via one or more TX chains and receiving the transmitted calibration signal via one or more RX chains. Calibration coefficients, which are indicative of offsets in response between the TX chains and the corresponding RX chains, are computed based on the received calibration signal. A self-calibrated beamformed signal is generated using the calibration coefficients. The self-calibrated beamformed signal is transmitted via the TX chains to a remote communication device.

### CROSS-REFERENCE TO RELATED APPLICATIONS

This application claims the benefit of U.S. Provisional Patent Application 61/786,998, filed Mar. 15, 2013, whose disclosure is incorporated herein by reference.

### FIELD OF THE INVENTION

The present invention relates generally to wireless communication, and particularly to methods and systems for implicit beamforming.

### BACKGROUND OF THE INVENTION

Beamforming is a communication technique in which a transmitter (referred to as a beamformer) transmits a directional transmission beam toward a receiver (referred to as a beamformee). Beamforming techniques are used in various types of communication systems. For example, IEEE Standard 802.11n-2009, entitled “IEEE Standard for Information Technology—Telecommunications and Information Exchange between Systems—Local and Metropolitan Area Networks—Specific Requirements; Part 11: Wireless LAN Medium Access Control (MAC) and Physical Layer (PHY) Specifications; Amendment 5: Enhancements for Higher Throughput,” October, 2009, which is incorporated herein by reference, specifies beamforming for Wireless LAN (WLAN, also referred to as Wi-Fi).

Beamforming techniques can be classified into explicit and implicit beamforming. In explicit beamforming, the beamformer receives feedback regarding the communication channel from the beamformee, and uses the feedback in producing the beamformed transmission beam. In implicit beamforming, the beamformer does not rely on feedback from the beamformee, and instead uses estimates of the opposite-direction channel, assuming channel reciprocity. Sections 9.19 and 20.3.12 of the IEEE 802.11n-2009 standard specifies beamforming in general. Implicit beamforming is addressed in Sections 20.3.12.1 and 9.19.2. Section 9.19.2.4 addresses calibration for implicit beamforming.

### SUMMARY OF THE INVENTION

An embodiment of the present invention that is described herein provides a method for communication. The method includes, in a communication device that includes a plurality of transmission/reception (TX/RX) chains, each including a respective TX chain and a respective RX chain coupled to a respective antenna, transmitting a calibration signal via one or more TX chains and receiving the transmitted calibration signal via one or more RX chains. Calibration coefficients, which are indicative of offsets in response between the TX chains and the corresponding RX chains, are computed based on the received calibration signal. A self-calibrated beamformed signal is generated using the calibration coefficients. The self-calibrated beamformed signal is transmitted via the TX chains to a remote communication device.

In some embodiments, generating the self-calibrated beamformed signal includes receiving an uplink signal from the remote communication device, estimating, based on the received uplink signal and on the calibration coefficients, a response of a downlink communication channel from the communication device to the remote communication device, and producing the self-calibrated beamformed signal using the estimated response of the downlink communication channel.

In some embodiments, computing the calibration coefficients includes transmitting the calibration signal from the TX chain of a first TX/RX chain to the RX chain of a second TX/RX chain so as to produce a first received signal, transmitting the calibration signal from the TX chain of the second TX/RX chain to the RX chain of the first TX/RX chain so as to produce a second received signal, and computing a calibration coefficient for the first TX/RX chain based on the first and second received signals. Computing the calibration coefficient may include deriving from the first received signal a first channel response of the TX chain of the first TX/RX chain and the RX chain of the second TX/RX chain, deriving from the second received signal a second channel response of the TX chain of the second TX/RX chain and the RX chain of the first TX/RX chain, and dividing the second channel response by the first channel response. In an embodiment, transmission of the calibration signal via the first TX/RX chain and via the second TX/RX chain are performed within no more than a maximum predefined time gap.

In another embodiment, the method includes preventing remote communication devices from causing interference to reception of the calibration signal, by notifying the remote communication devices that the communication device will be unavailable during a time interval that at least partially contains transmission of the calibration signal. In yet another embodiment, computing the calibration coefficients includes assigning one of the RX/RX chains to serve as a reference chain, and computing the calibration coefficients for the other TX/RX chains relative to the reference chain. In still another embodiment, transmitting and receiving the calibration signal include transmitting the calibration signal via a selected TX chain, and receiving the transmitted calibration signal simultaneously via two or more of the RX chains.

In some embodiments, transmitting and receiving the calibration signal include transmitting and receiving multiple carriers in respective frequency bins, and computing each calibration coefficient includes computing a set of frequency-bin-specific calibration coefficients corresponding to the respective frequency bins. In an example embodiment, transmitting and receiving the calibration signal include dividing the multiple carriers into subsets, and transmitting and receiving each subset at a different time. In another embodiment, computing the calibration coefficient includes interpolating the frequency-bin-specific calibration coefficients, so as to derive a frequency-bin-specific calibration coefficient for a frequency bin that is not covered by the calibration signal.

In some embodiments, transmitting and receiving the calibration signal includes setting the TX/RX chains to a first gain that is lower than a second gain used for communication with the remote communication device. Computing the calibration coefficients may include compensating for response differences in the TX/RX chains between the first and second gains. In a disclosed embodiment the method includes, in response to an event that causes a discontinuous change in a phase of the TX/RX chains, estimating the change in the phase and correcting the calibration coefficients to account for the estimated change.

There is additionally provided, in accordance with an embodiment of the present invention, a communication device including processing circuitry and a plurality of transmission/reception (TX/RX) chains. Each of the TX/RX chains includes a respective TX chain and a respective RX chain coupled to a respective antenna. The processing circuitry is configured to transmit a calibration signal via one or more TX chains, to receive the transmitted calibration signal via one or more RX chains, to compute, based on the received calibration signal, calibration coefficients indicative of offsets in response between the TX chains and the corresponding RX chains, to generate a self-calibrated beamformed signal using the calibration coefficients, and to transmit the self-calibrated beamformed signal via the TX chains to a remote communication device.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an Access Point (AP) that performs self-calibration for implicit feedback beamforming, in accordance with an embodiment of the present invention;

FIG. 2 is a flow chart that schematically illustrates a method for self-calibration for implicit feedback beamforming, in accordance with an embodiment of the present invention; and

FIG. 3 is a block diagram that schematically illustrates circuitry for calculation of calibration coefficients using an Orthogonal Frequency Division Multiplexing (OFDM) signal, in accordance with an embodiment of the present invention.

### DETAILED DESCRIPTION OF EMBODIMENTS

### Overview

Embodiments of the present invention that are described herein provide improved methods and systems for Implicit Beamforming (IBF). The disclosed techniques compensate for gain and phase imperfections in the beamformer hardware that may distort the IBF operation. The disclosed techniques are performed solely by the beamformer, without a need for cooperation with a beamformee or any other external entity. Although the embodiments described herein refer mainly to a WLAN Access Point (AP) as the beamformer, the disclosed techniques can be used in various other communication devices.

In some embodiments, the AP comprises multiple transmission/reception (TX/RX) chains. Each TX/RX chain comprises a TX chain and an RX chain, both coupled to a respective antenna. The AP further comprises processing circuitry that, among other tasks, uses IBF to transmit beamformed downlink signals to WLAN stations (STAs). In particular, the processing circuitry calculates beam steering matrices for beamforming the downlink signals based on received uplink signals.

Calculation of beam steering matrices using IBF typically assumes channel reciprocity, i.e., that the response of the downlink channel (from the AP to the STA) is similar to that of the uplink channel (from the STA to the AP). In practice, however, elements of the TX and RX chains often introduce gain and phase differences between the uplink and downlink channel responses. Unless accounted for, such differences may degrade the performance of implicit beamforming considerably.

In some embodiments, the processing circuitry in the AP performs a self-calibration process that measures and compensates for the differences in channel response between the TX and RX chains. The process typically produces a set of calibration coefficients, each coefficient indicative of the gain and phase difference between the TX chain and the RX chain of a respective TX/RX chain. In some embodiments, the calibration coefficients are calculated relative to a selected TX/RX chain that serves as a reference chain.

On transmission, the AP applies the calibration coefficients to the downlink signals to be transmitted via the respective TX chains. As a result, the transmitted signal is beamformed with high accuracy, irrespective of gain and phase differences between the TX and RX chains of the AP.

In the disclosed self-calibration processes, the AP transmits calibration signals via selected TX chains and receives the signals via selected RX chains. The air medium between the antennas thus serves as a loopback connection for the purpose of calibration, without a need for additional hardware. In some embodiments, the self-calibration process is made-up of a series of “calibration toggles.” In each calibration toggle the AP calculates the calibration coefficient for a given TX/RX chain relative to a reference chain by (1) transmitting a calibration signal from the given TX/RX chain to the reference chain, (2) transmitting a calibration signal in the opposite direction, i.e., from the reference chain to the given TX/RX chain, and (3) deriving the calibration coefficient for the given TX/RX chain based on the two received calibration signals.

Various design considerations and example implementations of the self-calibration process are described herein. In some embodiments the process is implemented in an Orthogonal Frequency Division Multiplexing (OFDM), such as an IEEE 802.11n WLAN.

As noted above, the calibration processes described herein are performed entirely in the AP, and do not require any interaction or cooperation with an STA or other entity other than the AP. The self-calibration process may be performed during production of the AP, in which case it simplifies and shortens the final testing and reduces production cost. Additionally or alternatively, the self-calibration process may be performed during normal operation of the AP in the field, resulting in highly accurate beamforming performance.

### System Description

FIG. 1 is a block diagram that schematically illustrates an Access Point (AP) 24 that performs self-calibration for implicit feedback beamforming, in accordance with an embodiment of the present invention. In the present example, AP 24 communicates with one or more stations (STAs) 28 as part of a Wireless Local Area Network (WLAN) 20 that operates in accordance with the IEEE 802.11n-2009 standard. In alternative embodiments, the disclosed techniques can be implemented in various other types of communication devices, systems and networks.

AP 24 comprises multiple transmission/reception (TX/RX) chains, each chain comprising a respective TX chain 32 and a respective RX chain 36 that are coupled to a respective antenna 40 through a respective Transmit/Receive (T/R) switch 42. The TX and RX chains perform analog and RF transmission and reception functions. The AP further comprises processing circuitry 44 that carries out the various digital and baseband processing tasks of the AP. Processing circuitry 44 comprises an Implicit Beamforming (IBF) self-calibration unit 48, whose functions are described in detail below.

The inset at the bottom of the figure shows the internal structure of a given TX/RX chain. The other TX/RX chains have a similar structure. In this example, TX chain 32 comprises a Digital-to-Analog Converter (DAC) that receives a digital signal from processing circuitry 44 and converts the signal to analog. An Up-converter 56 up-converts the signal to an appropriate Radio Frequency (RF). A Power Amplifier (PA) 60 amplifies the RF signal to the desired output power level, and provides the RF signal to antenna 40 via T/R switch 42. RX chain 36 comprises a Low-Noise Amplifier (LNA) 64 that amplifies the RF signal received by antenna 40. A down-converter 68 down-converts the RF signal. An Analog-to-Digital Converter (ADC) 72 samples (digitizes) the signal and provides the digital signal to processing circuitry 44.

The configuration of AP 24 shown in FIG. 1 is an example configuration, which is chosen purely for the sake of conceptual clarity. In alternative embodiments, any other suitable AP configuration can be used. For example, some of the functions of IBF self-calibration unit 48 (e.g., calculation of calibration weights) may be performed by a processor outside the AP. Some elements of AP 24 may be implemented in hardware, e.g., in one or more Application-Specific Integrated Circuits (ASICs) or Field-Programmable Gate Arrays (FPGAs). Additionally or alternatively, some elements of AP 24, such as unit 48 or other parts of processing circuitry 44, can be implemented using software, or using a combination of hardware and software elements.

Some of the functions of AP 24, such as some or all of the functions of unit 48 or other parts of processing circuitry 44, may be carried out using a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Self-Calibration for Implicit Beamforming

In some embodiments, AP 24 communicates with STAs 28 using implicit beamforming. In order to transmit a directional transmission beam toward a given STA 28, processing circuitry 44 applies an appropriate beam steering matrix to the vector of signals to be transmitted via the respective TX chains. The beam steering matrix effectively multiplies the signal of each TX chain by a respective complex weight, so as to produce the desired beam.

When using implicit beamforming vis-à-vis a certain STA 28, AP 24 typically receives uplink signals from the STA using RX chains 36, estimates the response of the (MIMO) uplink channel from the STA to the AP. The AP then calculates the beam steering matrix using the uplink channel response, under an assumption that the channel is reciprocal, i.e., that the response of the downlink channel (from the AP to the STA) is similar to that of the uplink channel (from the STA to the AP).

The assumption of channel reciprocity may hold for the wireless medium and for some components such as antennas 40. In practice, however, elements of the TX and RX chains often introduce gain and phase differences between the uplink and downlink channel responses. Unless accounted for, such differences may degrade the performance of implicit beamforming considerably.

In some embodiments, IBF self-calibration unit 48 carries out a self-calibration process that compensates for the differences in channel response between the TX and RX chains. The disclosed calibration process is performed entirely in AP 24, without a need for cooperation with any STA 28 or any other entity external to the AP.

In principle, the calibration process estimates, for each TX/RX chain, a calibration coefficient that is indicative of the ratio between the response of the TX chain and the response of the RX chain. The calibration coefficient is typically a complex number that accounts for both gain and phase differences. When producing the beamformed signal for transmission, processing circuitry 44 multiplies the signal transmitted via each TX chain by the calibration coefficient estimated for that chain. As a result, the reciprocity assumption is restored and the beamformed signal is not degraded due to the TX/RX channel response differences.

In some embodiments, unit 48 regards one of the TX/RX chains as a reference chain and sets the calibration coefficient for this chain to unity. The calibration coefficients for the other TX/RX chains are estimated relative to the reference chain. Since the beamforming operation is agnostic to multiplication of all signals by a constant, estimating the calibration coefficients relative to the reference chain is equivalent to estimating the absolute TX/RX response ratios per chain. For N TX/RX chains, the resulting (relative) calibration coefficients are denoted \tilde{C}ᵢ, i=1 . . . N. By definition, when j denotes the index of the reference chain, \tilde{C}ⱼ=1.

Typically, unit 48 estimates the calibration coefficients \tilde{C}ᵢ by transmitting signals from one or more of the TX chains and receiving the signals in one or more of the RX chains. For a given pair of TX chain and RX chain, the signal traverses a channel formed by the air medium between antennas 40 of the TX and RX chains, which acts as a loopback connection. In this manner, there is no need for cooperation with any external entity for performing the calibration process. Moreover, this form of loopback ensures that the entire TX chain and RX chain, including the antennas, are accounted for in estimating the calibration coefficient.

Consider a known signal that is transmitted via the i^{th} TX chain and received via the j^{th} RX chain. The overall response affecting this signal can be written as:

T_{i→j}=K_{RX,j}·H_{i→j}·K_{TX,i}

wherein K_{RX,j} denotes the response of the j^{th} RX chain, denotes the response of the channel from the i^{th} antenna to the j^{th} antenna, and K_{TX,i} denotes the response of the i^{th} TX chain. Consider now a known signal that is transmitted in the opposite direction, i.e., transmitted via the j^{th} TX chain and received via the i^{th} RX chain. The overall response affecting this signal can be written as:

T_{j→i}=K_{RX,i}·H_{j→i}·K_{TX,j}

Assuming that the wireless channel is reciprocal, i.e., that H_{i→j}=H_{j→i}, it is possible to derive the calibration coefficient \tilde{C}ᵢ of the i^{th} TX/RX chain (relative to the j^{th} TX/RX chain, which is regarded as the reference chain in this example):

$$\frac{{T}_{j -> i}}{{T}_{i -> j}} = \frac{{K}_{TX , j}}{{K}_{RX , j}} \cdot \frac{{K}_{RX , i}}{{K}_{TX , i}} = \frac{{C}_{i}}{{C}_{j}} = {\tilde{C}}_{i}$$

Thus, in some embodiments unit 48 transmits a signal via the i^{th} TX chain, receives the signal via the j^{th} RX chain and estimates T_{i→j}. Similarly, unit 48 transmits a signal via the j^{th} TX chain, receives the signal via the i^{th} RX chain and estimates T_{j→i}. From these two estimates, unit 48 computes \tilde{C}ᵢ, with \tilde{C}ⱼ set to unity by definition. This process may be repeated for all i, i≠j. One way of applying the calibration coefficients \tilde{C}ᵢ during beamforming is to multiply the signal transmitted via the i^{th} TX chain by \tilde{C}ᵢ.

The above technique assumes that the wireless channel is reciprocal, i.e., that H_{i→j}=H_{j→i}. In order to ensure that this assumption holds, unit 48 typically measures T_{i→j} and T_{j→i} in time proximity to one another, e.g., with no more than a predefined time difference or time gap between the two measurements. This constraint reduces distortion that may be caused, for example, by variations in the channel, interference from other signals, or hardware drifts (e.g., VCO wander) that changes the TX chain or RX chain response over time.

Consider, for example, a configuration in which AP 24 comprises four TX/RX chains. In an example embodiment, unit 48 defines the first TX/RX chain as a reference chain, and calculates the calibration coefficients for the other three TX/RX chains relative to this reference chain. Thus, unit 48 calculates three ratios:

$${\tilde{C}}_{2} ≡ \frac{{C}_{2}}{{C}_{1}} , {\tilde{C}}_{3} ≡ \frac{{C}_{3}}{{C}_{1}} , {\tilde{C}}_{4} ≡ \frac{{C}_{4}}{{C}_{1}}$$

In practice, it may be preferable to perform the actual response measurements (measurements of T_{i→j} and T_{j→i}) with respect to the same reference chain. For example, it may be preferable not to perform response measurements between antennas that are adjacent or otherwise very close to one another, in order to avoid signal compression. In some embodiments, unit 48 performs response measurements between various pairs of TX/RX chains, without necessarily using a single reference chain that is common to all pairs. Unit 48 translates these measurements by calculation into calibration coefficients relative to a common reference TX/RX chain.

For example, in a four-chain AP configuration, unit may measure the response for antenna pairs {#1,#2}, {#2,#3} and {#3,#4}, i.e., measure the ratios

$$\frac{{C}_{2}}{{C}_{1}} , \frac{{C}_{3}}{{C}_{2}} , \frac{{C}_{4}}{{C}_{3}}$$

and translate these ratios into the desired calibration coefficients \tilde{C}₂, \tilde{C}₃, \tilde{C}₄ by multiplying the measured ratios by one another. For example, \tilde{C}₃ can be calculated by

$${\tilde{C}}_{3} ≡ \frac{{C}_{3}}{{C}_{1}} = \frac{{C}_{3}}{{C}_{2}} \cdot \frac{{C}_{2}}{{C}_{1}}$$

Alternatively, any other suitable pairs of TX/RX chains can be measured, and the measurements translated into calibration coefficients. Regardless of the specific choice of antenna pairs to be measured, the self-calibration process can be viewed as a sequence of “calibration toggles.” Each calibration toggle comprises a measurement of T_{i→j} by transmitting via the i^{th} TX chain and receiving via the j^{th} RX chain, and a measurement of T_{j→i} by transmitting via the j^{th} TX chain and receiving via the i^{th} RX chain. As noted above, each calibration toggle should be performed within a short predefined time gap or interval.

In some embodiments, scheduling of the calibration toggle is performed using hardware rather than software. Hardware implementation enables the processing circuitry to perform both measurements of the calibration toggle (T_{i→j} and T_{j→i}) within a short time interval, thereby improving reciprocity. Triggering of the toggle may be performed by software, but the toggle operation itself is preferably (although not necessarily) performed in hardware.

In some embodiments, unit 48 shortens the calibration time by receiving using multiple RX chains when a given TX chain transmits the calibration signal. In an example embodiment, when the i^{th} TX chain transmits, the remaining N−1 RX chains receive and measure the respective N−1 responses (T_{i→j}, j=1 . . . N, j≠i). In this embodiment, unit 48 performs the entire calibration process using N transmit operations. While shortening the calibration time, this technique may involve more buffering and, for some of the calibration toggles, increase the time difference between the two parts of the toggle.

In some embodiments, unit 48 performs the disclosed self-calibration process during system initialization or power-up. Additionally or alternatively, unit 48 may perform calibration during normal operation of WLAN 20, e.g., at periodic intervals, upon a change in operating conditions (e.g., a change in temperature), upon detecting performance degradation that may be attributed to poor calibration, or at any other suitable time or in response to any other suitable condition.

When performing calibration during normal system operation, unit 48 may perform the process intermittently, e.g., one calibration toggle at a time, so as not to disrupt communication with the STAs for long time periods. Since the duration of each calibration toggle is typically no more than a packet length, intermittent calibration is usually tolerable.

In some embodiments, unit 48 repeats each calibration toggle (or only selected calibration toggles) more than once, in order to average measurement noise, and improve calibration accuracy and robustness. In an embodiment, each calibration toggle is divided into several short measurement intervals instead of a single longer interval. Short measurement intervals are useful, for example, when the calibration process is performed during normal system operation, because it enables the AP to suspend communication with the STAs for shorter periods of time. Short measurement intervals also help to reduce buffering requirements.

Unit 48 may use various techniques to interleave the calibration process with the normal WLAN operation, in order to minimize disruption of communication with STAs. In some embodiments, unit 48 sends a request to perform a calibration operation (which may comprise one or more calibration toggles) to a Medium Access Control (MAC) layer in the processing circuitry. The MAC layer selects a suitable time for performing the calibration operation, and grants unit 48 permission to access the wireless medium at the selected time.

In an example embodiment, the MAC layer uses a Clear Channel Assessment (CCA) signal (also referred to as carrier sense signal) that indicates whether the channel is clear. The MAC layer times the calibration operation to a time at which the CCA signal indicates a clear channel (otherwise the calibration operation may disrupt traffic or be corrupted by outside interference). If calibration is requested during packet reception or transmission, the MAC layer will typically conclude the reception or transmission operation before starting calibration. Calibration may be scheduled immediately after the CCA signal indicates that the channel becomes clear. After the calibration operation completes, the AP may immediately resume normal operation, and the captured calibration signals can be processed off-line.

In some embodiments, unit 48 protects a time interval that contains at least part of the calibration duration (e.g., a given calibration toggle) from interference caused by STAs 28 by notifying the STAs that the AP will be unavailable during this time interval. In IEEE 802.11n WLANs, for example, the AP may transmit a CTS-to-self frame, which includes a NAV field that covers the duration of the calibration toggle. As a result, the STAs will not transmit to the AP during the time interval, and will therefore not interfere with the self-calibration process.

To maintain coherence between the two parts of a calibration toggle, the delay between the start of transmission and the start of capturing the received signal is typically constant and known. The capture may start simultaneously with the transmission operation, or at a known and consistent time offset that can be a system configuration parameter. Setting a non-zero time offset also helps to avoid transient effects that may occur at the beginning of transmission.

In some practical cases, the signal captured during a calibration toggle may be corrupted, e.g., due to interference or due to an abrupt change in channel conditions. In some embodiments, unit 48 verifies the validity of the calibration results before using them. This sort of validation is important, since corrupted calibration coefficients may corrupt the entire beamforming operation. Unit 48 may verify the calibration results in various ways. In one embodiment, unit 48 compares the calibration results to baseline results of previous calibration operations, and discards the current results if they deviate from the baseline results (e.g. in average phase and/or gain) by more than a predefined tolerable deviation. The above verification is best suited for calibration performed during normal system operation. On system power-up, unit 48 may perform each calibration toggle several times and discard results that deviate from the average or expected result.

FIG. 2 is a flow chart that schematically illustrates a method for self-calibration for implicit feedback beamforming, in accordance with an embodiment of the present invention. The method begins with self-calibration IBF unit 48 transmitting signals via one or more of TX chains 32, at a transmission step 80. Unit 48 receives the signals using one or more of RX chains 36, at a reception step 84.

Unit 48 computes calibration coefficients \tilde{C}ᵢ, also referred to as compensation ratios, by processing the received signals, at a compensation computation step 88. Processing circuitry 44 calibrates the beam steering configuration using the calibration coefficients, at a calibration step 92. In some embodiments, unit 48 applies the calibration coefficients to the signals to be transmitted via the respective TX chains. In alternative embodiments, unit 48 applies the calibration coefficients to the beam steering matrices used for beamforming the signals. Processing circuitry 44 then transmits the self-calibrated beamformed signal, at a communication step 96.

### Example Implementation in OFDM System

In some embodiments, such as in IEEE 802.11n-2009 WLANs, AP 24 transmits OFDM signals to the STAs. The OFDM signal comprises multiple sub-carriers in respective frequency bins. In many practical cases, the responses of the TX and RX chains are frequency-dependent. As such, the difference between the TX chain response and the RX chain response in a given TX/RX chain may be frequency-dependent, as well.

In order to account for this frequency dependence, in some embodiments unit 48 calculates and uses calibration coefficients \tilde{C}ᵢ per frequency bin, or at least per spectral sub-band that includes a number of bins. The results of such a calibration process is a set of calibration vectors denoted \tilde{C}ᵢ, i=1 . . . N. The j^{th} calibration vector \tilde{C}ⱼ comprises the calibration coefficients for the j^{th} TX/RX chain, per frequency bin.

In some embodiments, unit 48 estimates all the elements of a calibration vector \tilde{C}ⱼ simultaneously, by transmitting a known OFDM signal and analyzing the Fast Fourier Transform (FFT) of the received signal. When beamforming the OFDM signal prior to transmission, unit 48 may apply the calibration vectors to the signal in the frequency domain, before the signal is transformed into time domain for transmission (e.g., before Inverse FFT—IFFT).

In practice, transmission of an OFDM calibration signal having subcarriers in adjacent frequency bins may cause phase estimation errors, e.g., due to inter-carrier interference or signal compression. To avoid this distortion, in some embodiments unit 48 uses OFDM calibration signals that are sparse in frequency. In each such signal, the frequency separation between subcarriers is at least a predefined number of bins.

In an embodiment, unit 48 calculates the calibration coefficients for frequency bins that are not covered by the calibration signal using interpolation (e.g., using Zero-Order Hold—ZOH). Alternatively, unit 48 may transmit multiple calibration signals at different times, such that each signal is sparse but the multiple signals together cover all the frequency bins. In this embodiment, each calibration toggle involves transmission of multiple calibration signals. The timing constraint on the two parts of the toggle, however, applies only between transmissions of the same calibration signal.

Typically, the calibration signal used for performing the disclosed self-calibration process is both generated and captured digitally in processing circuitry 44, in order to calibrate all possible sources of gain and phase differences. In an embodiment, the samples of the transmitted signal are stored in a memory buffer. When calibrating a certain TX chain 32 and a certain RX chain, unit 48 transmits the buffered samples cyclically via the TX chain being calibrated, and captures the signal via the RX chain being calibrated.

In an OFDM system, the calibration signal may be generated either in the frequency domain or in the time domain. In an embodiment, processing circuitry 44 generates a time-domain signal at the OFDM FFT sample rate (even though the actual digital signal is typically up-sampled before DAC 52). In the RX chain, the received signal is typically captured at the OFDM FFT sample rate, after down-sampling following ADC 72. This form of signal generation and capture also accounts for gain and phase differences caused by digital circuitry in the TX and RX chains. Although such differences are usually deterministic, it is still convenient to include them in the calibration path. Signal generation and capture using lower sampling rate also reduces the required buffer size.

Processing circuitry 44 typically comprises a set of buffers for capturing the calibration signal being received. Typically, the buffers should be sufficiently large to accommodate both parts of a calibration toggle, since these signals are typically received immediately one after another.

FIG. 3 is a block diagram that schematically illustrates circuitry for calculation of calibration coefficients using an OFDM signal, in accordance with an embodiment of the present invention. This circuitry is typically implemented as part of processing circuitry 44, e.g., as part of unit 48.

In the present example, the first TX/RX chain serves as a reference chain, and the circuitry computes the calibration coefficient \tilde{C}ₙ for the n^{th} TX/RX chain based on a single calibration toggle. The calibration toggle between the 1^{st} and n^{th} TX/RX chains produces two received calibration signals denoted X̅_{1→n} and X̅_{n→1}.

In the present example, the two signals are first decimated using respective decimation filters 100 and then stored in respective calibration buffers 104. These operations are performed in real time during the calibration toggle. Subsequent operations can be performed off-line. In an alternative embodiment, buffers 104 are located before decimation filters 100. This implementation requires large buffers in order to store the signal before decimation, but enables the decimation to be performed off-line as well.

Respective FFT units 106 convert the buffered time-domain calibration signals to the frequency domain. The resulting frequency-domain calibration signals are denoted X̅f̅_{1→n} and X̅f̅_{n→1}. Each frequency-domain signal comprises a vector whose elements correspond to the respective OFDM sub-carriers (or frequency bins). A complex vector division unit 112 divides X̅f̅_{n→1} by X̅f̅_{1→n}, element by element, to produce a calibration vector \tilde{C}ₙ whose elements are the calibration coefficients per frequency bin.

As explained above, in some embodiments the calibration signal covers only a sparse subset of the frequency bins. In these embodiments, an interpolation module 116 calculates the calibration coefficients for the frequency bins that are not covered by the signal. Module 116 may perform any suitable type of interpolation on the elements of \tilde{C}ₙ, for example Zero-Order Hold (ZOH). In alternative embodiments, the calibration toggle can be repeated using one or more other calibration signals, so as to jointly cover all frequency bins.

In some embodiments, each buffer 104 is dimensioned so as to capture at least one FFT period. Capturing of several FFT periods can be used to average the signal, either before or after the FFT operation.

In an embodiment, for an N-antenna system, unit 48 performs N−1 calibration toggles. Each calibration toggle involves two transmit operations. The total number of transmit operations is therefore 2(N−1). In an alternative embodiment, unit 48 performs N transmit operations, one for each antenna. During each transmission operation, the calibration signal is received by all other antenna simultaneously. When using sparse calibration signals (e.g., sparse frequency-domain combs), unit 48 may repeat each calibration toggle several times, each time with a signal having a different frequency offset.

### TX/RX Chain Gain Considerations

In practice, antennas 40 are often very close to one another, and the path loss of the air channel between the antennas is therefore small. The small path loss should be considered when designing the self-calibration process, in order not to cause receiver saturation and signal compression. Such effects may occur both at the receiver RF circuitry and in ADC 72.

In some embodiments, unit 48 configures the TX chains to transmit at low power during self-calibration (relative to the normal transmit power used for communication with STAs 28). Reduction of transmit power can be applied digitally (i.e., before DAC 52), in the analog domain (i.e., after the DAC) or both. Additionally, unit 48 also configures the RX chains to a low gain setting during self-calibration (relative to the normal receiver gain used for communication with STAs 28). Receiver gain can be set at RF (e.g., by controlling the gain of LNA 64), at baseband (e.g., using a Variable-Gain Amplifier (VGA) in down-converter 68), or both.

Since different antenna pairs may differ from one another in distance (and thus in path loss), unit 48 may set different TX and/or RX gain settings for different calibration toggles.

Unit 48 typically acquires the appropriate TX and RX gains for each calibration toggle at system power-up. In an embodiment, unit 48 initially sets the receiver Automatic Gain Control (AGC) setting that is used for normal communication. Alternatively, a separate AGC loop can be used for calibration.

Typically, the gain variation between the two parts of a given calibration toggle is small. Therefore, in some embodiments unit 48 sets the gain for a given calibration toggle according to the stronger signal X_{i→j} or X_{j→i}. In some embodiments, unit 48 may set the AGC gain for a given calibration toggle iteratively. For example, a first iteration of the calibration toggle may be performed using default gain settings. Then, the stronger signal in the calibration toggle (X_{i→j} or X_{j→i}) is compared to a threshold, and a gain change is possibly made in the next iteration according to the distance of the signal level from the threshold.

After acquiring an initial TX and RX gain setting for each calibration toggle (i.e., for each pair of TX chain and RX chain to be calibrated), unit 48 tracks the actual signal strengths during operation, and adjusts the gain settings if necessary. Since gain changes during operation are usually small (typically caused by temperature changes), the AGC mechanism may compare the signal strengths of two consecutive calibration processes, and change the gain before the next calibration process.

Another factor that should be accounted for is relative phase changes between different gain settings in the TX or RX chains. For example, the LNA or VGA in the RX chain may exhibit different transfer phases at different gain settings. When the actual implicit beamforming operation is performed at a different gain setting than the calibration process (in transmission and/or reception), these phase differences may degrade the beamforming performance.

Unit 48 may overcome the effect of such phase differences in various ways. In one embodiment, unit 48 pre-characterizes the phase differences between different gain settings. When applying the calibration coefficients to a particular beam steering vector, processing circuitry 44 may compensate for the phase differences using the pre-characterization results. More specifically, when applying the calibration coefficient in a given TX/RX chain, unit 48 uses the pre-characterization results to compensate for the difference in the transfer phase of the RX chain between the gain setting used for calibration and the gain used for receiving the signal from which the beam steering vector was derived.

In another embodiment, processing circuitry 48 forces the same LNA gain setting in all RX chains 36 during uplink receptions from which a steering vector is to be derived. Thus, processing circuitry 48 may carry out one AGC algorithm in frames from which a steering vector is to be derived, and a different AGC algorithm in other frames.

Since the relative phase between the receive chains is usually insensitive to the absolute LNA gain, forcing the same LNA gain in all RX chains is accurate even if this gain setting is different from the setting used during calibration. Nevertheless, the LNA gain setting should be essentially the same on both directions of a calibration toggle (particularly when multiple RX chains receive simultaneously the calibration signal from one of the TX chains).

In some embodiments, AP 24 supports several bandwidth modes, e.g., it may be capable of communicating over a 20 MHz, 40 MHz or 80 MHz bandwidth in accordance with IEEE 802.11ac. In each bandwidth mode the AP typically uses different baseband (analog and digital) filters. In some embodiments, unit 48 repeats the self-calibration process in each bandwidth mode. In another embodiment, unit 48 performs the self-calibration process in the widest-bandwidth mode, and applies suitable gain/phase corrections to account for differences between the modes. The gain/phase corrections can be obtained, for example, from a-priori characterization data.

### Fast Compensation for Discontinuous Change in TX/RX Chain Phase

Some events, such as switching from one RF channel to another, may cause a discontinuous change in the transfer phases of the TX and/or RX chains. For example, in some VCO or mixer implementation, a change of channel may cause the transfer phase of the RX or TX chain to change at random by an integer multiple of 90°, i.e., by 0°, 90°, 180° or 270°. This phase change should be accounted for before applying the calibration coefficients.

A naïve solution to this problem would be to repeat the entire self-calibration process after each such event, and discard the calibration coefficients used before the event. This solution, however, is highly inefficient and time consuming. In some embodiments, unit 48 estimates the discontinuous phase change and corrects the existing calibration coefficients, without having to repeat the self-calibration process.

In the k^{th} TX/RX chain, the event causes the phase difference between TX chain 32 and RX chain 36 to change by

Δφₖ=ExtraPhase(TXₖ)−ExtraPhase(RXₖ)

As noted above, it is sufficient to estimate Δφₖ relative to some reference chain. In other words, it is sufficient to estimate Δφₖ up to a constant Δφ that is the same for all TX/RX chains.

In some embodiments, unit 48 estimates Δφₖ from a pair of received signal vectors { X̅_{1→n}, X̅_{n→1}} acquired before the event that caused the phase change, and a pair of vectors { Y̅_{1→n}, Y̅_{n→1}} acquired for the same pair of chains after the event. In some embodiments, vectors { Y̅_{1→n}, Y̅_{n→1}} can be measured using a simpler calibration signal, e.g., a single tone.

In an example embodiment, unit 48 calculates a cross-correlation between a vector that was acquired after the event and a vector that was acquired before the event. The cross-correlation result comprises a complex number, whose phase represents a sum of the extra phases. For the first and second chains, for example:

$${S}_{1} = {\sum }_{m} {\overline{Y}}_{1 -> 2} [ m ] \cdot {{\overline{X}}_{1 -> 2} [ m ]}^{*}$$

$${S}_{2} = {\sum }_{m} {\overline{Y}}_{2 -> 1} [ m ] \cdot {{\overline{X}}_{2 -> 1} [ m ]}^{*}$$

$$Angle ( {S}_{1} ) = ExtraPhase ( {TX}_{1} ) + ExtraPhase ( {RX}_{2} )$$

$$Angle ( {S}_{2} ) = ExtraPhase ( {TX}_{2} ) + ExtraPhase ( {RX}_{1} )$$

The desired calibration phase is the phase difference between the two cross-correlation results:

L=S₂S₁*

Angle(L)=Δφ₂−Δφ₁

In some embodiments, processing circuitry 44 can apply Angle(L) directly to correct the calibration vectors. Alternatively, Angle(L) can be rounded to the nearest integer multiple of the expected phase change. For example, if the discontinuous phase change is an integer multiple of 90°, Angle(L) can be rounded and the correction factor for the second chain is thus given by

$${Corr}_{2} = {e}^{i∅}$$

$$∅ ∈ \{ 0 , \frac{π}{2} , π , \frac{3 π}{2} \}$$

The calibration vector of the n^{th} TX/RX chain, \tilde{C}ₙ, is thus multiplied by the (complex) scalar correction factor Corrₙ, to produce the corrected calibration vector.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for communication, comprising:
in a communication device that includes a plurality of transmission/reception (TX/RX) chains, each comprising a respective TX chain and a respective RX chain coupled to a respective antenna, transmitting a calibration signal via one or more TX chains and receiving the transmitted calibration signal via one or more RX chains;
computing, based on the received calibration signal, calibration coefficients indicative of offsets in response between the TX chains and the corresponding RX chains;
generating a self-calibrated beamformed signal using the calibration coefficients; and
transmitting the self-calibrated beamformed signal via the TX chains to a remote communication device.

2. The method according to claim 1, wherein generating the self-calibrated beamformed signal comprises receiving an uplink signal from the remote communication device, estimating, based on the received uplink signal and on the calibration coefficients, a response of a downlink communication channel from the communication device to the remote communication device, and producing the self-calibrated beamformed signal using the estimated response of the downlink communication channel.

3. The method according to claim 1, wherein computing the calibration coefficients comprises transmitting the calibration signal from the TX chain of a first TX/RX chain to the RX chain of a second TX/RX chain so as to produce a first received signal, transmitting the calibration signal from the TX chain of the second TX/RX chain to the RX chain of the first TX/RX chain so as to produce a second received signal, and computing a calibration coefficient for the first TX/RX chain based on the first and second received signals.

4. The method according to claim 3, wherein computing the calibration coefficient comprises deriving from the first received signal a first channel response of the TX chain of the first TX/RX chain and the RX chain of the second TX/RX chain, deriving from the second received signal a second channel response of the TX chain of the second TX/RX chain and the RX chain of the first TX/RX chain, and dividing the second channel response by the first channel response.

5. The method according to claim 3, wherein transmission of the calibration signal via the first TX/RX chain and via the second TX/RX chain are performed within no more than a maximum predefined time gap.

6. The method according to claim 1, and comprising preventing remote communication devices from causing interference to reception of the calibration signal, by notifying the remote communication devices that the communication device will be unavailable during a time interval that at least partially contains transmission of the calibration signal.

7. The method according to claim 1, wherein computing the calibration coefficients comprises assigning one of the RX/RX chains to serve as a reference chain, and computing the calibration coefficients for the other TX/RX chains relative to the reference chain.

8. The method according to claim 1, wherein transmitting and receiving the calibration signal comprise transmitting the calibration signal via a selected TX chain, and receiving the transmitted calibration signal simultaneously via two or more of the RX chains.

9. The method according to claim 1, wherein transmitting and receiving the calibration signal comprise transmitting and receiving multiple carriers in respective frequency bins, and wherein computing each calibration coefficient comprises computing a set of frequency-bin-specific calibration coefficients corresponding to the respective frequency bins.

10. The method according to claim 9, wherein transmitting and receiving the calibration signal comprise dividing the multiple carriers into subsets, and transmitting and receiving each subset at a different time.

11. The method according to claim 9, wherein computing the calibration coefficient comprises interpolating the frequency-bin-specific calibration coefficients, so as to derive a frequency-bin-specific calibration coefficient for a frequency bin that is not covered by the calibration signal.

12. The method according to claim 1, wherein transmitting and receiving the calibration signal comprises setting the TX/RX chains to a first gain that is lower than a second gain used for communication with the remote communication device.

13. The method according to claim 12, wherein computing the calibration coefficients comprises compensating for response differences in the TX/RX chains between the first and second gains.

14. The method according to claim 1, and comprising, in response to an event that causes a discontinuous change in a phase of the TX/RX chains, estimating the change in the phase and correcting the calibration coefficients to account for the estimated change.

15. A communication device, comprising:
a plurality of transmission/reception (TX/RX) chains, each comprising a respective TX chain and a respective RX chain coupled to a respective antenna; and
processing circuitry, which is configured to transmit a calibration signal via one or more TX chains, to receive the transmitted calibration signal via one or more RX chains, to compute, based on the received calibration signal, calibration coefficients indicative of offsets in response between the TX chains and the corresponding RX chains, to generate a self-calibrated beamformed signal using the calibration coefficients, and to transmit the self-calibrated beamformed signal via the TX chains to a remote communication device.

16. The communication device according to claim 15, wherein the TX/RX chains are configured to receive an uplink signal from the remote communication device, and wherein the processing circuitry is configured to estimate, based on the received uplink signal and on the calibration coefficients, a response of a downlink communication channel from the communication device to the remote communication device, and to produce the self-calibrated beamformed signal using the estimated response of the downlink communication channel.

17. The communication device according to claim 15, wherein the processing circuitry is configured to transmit the calibration signal from the TX chain of a first TX/RX chain to the RX chain of a second TX/RX chain so as to produce a first received signal, to transmit the calibration signal from the TX chain of the second TX/RX chain to the RX chain of the first TX/RX chain so as to produce a second received signal, and to compute a calibration coefficient for the first TX/RX chain based on the first and second received signals.

18. The communication device according to claim 17, wherein the processing circuitry is configured to compute the calibration coefficient by deriving from the first received signal a first channel response of the TX chain of the first TX/RX chain and the RX chain of the second TX/RX chain, deriving from the second received signal a second channel response of the TX chain of the second TX/RX chain and the RX chain of the first TX/RX chain, and dividing the second channel response by the first channel response.

19. The communication device according to claim 17, wherein the processing circuitry is configured to transmit the calibration signal via the first TX/RX chain and via the second TX/RX chain within no more than a maximum predefined time gap.

20. The communication device according to claim 15, wherein the processing circuitry is configured to prevent remote communication devices from causing interference to reception of the calibration signal, by notifying the remote communication devices that the communication device will be unavailable during a time interval that at least partially contains transmission of the calibration signal.

21. The communication device according to claim 15, wherein the processing circuitry is configured to assign one of the RX/RX chains to serve as a reference chain, and to compute the calibration coefficients for the other TX/RX chains relative to the reference chain.

22. The communication device according to claim 15, wherein the processing circuitry is configured to transmit the calibration signal via a selected TX chain, and to receive the transmitted calibration signal simultaneously via two or more of the RX chains.

23. The communication device according to claim 15, wherein the processing circuitry is configured to transmit and receive the calibration signal by transmitting and receiving multiple carriers in respective frequency bins, and to compute each calibration coefficient by computing a set of frequency-bin-specific calibration coefficients corresponding to the respective frequency bins.

24. The communication device according to claim 23, wherein the processing circuitry is configured to divide the multiple carriers into subsets, and to transmit and receive each subset at a different time.

25. The communication device according to claim 23, wherein the processing circuitry is configured to interpolate the frequency-bin-specific calibration coefficients, so as to derive a frequency-bin-specific calibration coefficient for a frequency bin that is not covered by the calibration signal.

26. The communication device according to claim 15, wherein the processing circuitry is configured to set the TX/RX chains to a first gain that is lower than a second gain used for communication with the remote communication device.

27. The communication device according to claim 26, wherein the processing circuitry is configured to compensate for response differences in the TX/RX chains between the first and second gains.

28. The communication device according to claim 15, wherein, in response to an event that causes a discontinuous change in a phase of the TX/RX chains, the processing circuitry is configured to estimate the change in the phase and to correct the calibration coefficients so as to account for the estimated change.
